(19) United States
(12) Patent Application Publication
(10) Pub. No.: US 2014/0293476 A1
(43) Pub. Date: Oct. 2, 2014

(54) SPINDLE MOTOR AND HARD DISK DRIVE INCLUDING THE SAME

(71) Applicant: SAMSUNG ELECTRO-MECHANICS CO., LTD., Suwon (KR)

(72) Inventor: Jin Young CHOI, Suwon (KR)

(73) Assignee: Samsung Electro-Mechanics Co., Ltd., Suwon (KR)

(21) Appl. No.: 13/933,279

(22) Filed: Jul. 2, 2013

(30) Foreign Application Priority Data
Mar. 29, 2013 (KR) 10-2013-0034271

(51) Int. Cl. H02K 5/15; G11B 5/54

(52) U.S. Cl. CPC H02K 5/15; G11B 5/54
USPC 360/75; 310/425

(57) ABSTRACT

There are provided a spindle motor and a hard disk drive including the same. The spindle motor includes a base member including a mounting part, and a hydrodynamic bearing assembly having a portion thereof fitted and fixed to the mounting part, wherein any one of the mounting part and the hydrodynamic bearing assembly includes a welding reinforcing protrusion protruding from a lowest portion thereof in an axial direction in a portion in which the mounting part and the hydrodynamic bearing assembly face each other, in a direction toward the other of the mounting part and the hydrodynamic bearing assembly, and overlapping the other thereof in the axial direction, and the mounting part and the hydrodynamic bearing assembly may be coupled to each other by lap welding in the axial direction through the welding reinforcing protrusion.

### CROSS-REFERENCE TO RELATED APPLICATIONS

This application claims the priority of Korean Patent Application No. 10-2013-0034271 filed on Mar. 29, 2013, in the Korean Intellectual Property Office, the disclosure of which is incorporated herein by reference.

### BACKGROUND OF THE INVENTION

1. Field of the Invention

The present invention relates to a spindle motor and a hard disk drive including the same.

2. Description of the Related Art

A hard disk drive (HDD), an information storage device, reads data stored on a disk or writes data to the disk using a read/write head.

The hard disk drive requires a disk driving device capable of driving the disk. Here, as the disk driving device, a small-sized motor has been used.

The small spindle motor has used a hydrodynamic bearing assembly. A lubricating fluid is interposed between a shaft and a sleeve of the hydrodynamic bearing assembly, such that the shaft is supported by a fluid pressure generated in the lubricating fluid.

Here, as a method for fixing the hydrodynamic bearing assembly to a base member, there various methods may be used, such as a welding method, a caulking method, a bonding method, and the like, which may be optionally applied, depending on structures and manufacturing processes of products.

In particular, the adhesive bonding has a weaker unmating force than the welding to break a bonded layer when a mechanical impact or a thermal impact is applied to a product, which may lead to degradations in product performance.

Therefore, a need exists for an inter-member coupling method capable of withstanding an external impact by simplifying a process and improving unmating force.

The following Related Art Document discloses a configuration that bonds the sleeve to the base member using the adhesive bonding method and the welding method. However, even in the case that the sleeve is bonded to the base member by the configuration, sufficient bonding strength may not be obtained.

### RELATED ART DOCUMENT

(Patent Document 1) Korean Patent Laid-open Publication No. 2012-0095643

### SUMMARY OF THE INVENTION

An aspect of the present invention provides a spindle motor in which a welding process may be very simply performed while improving unmating force between a sleeve or a holder and a base member.

According to an aspect of the present invention, there is provided a spindle motor, including: a base member including a mounting part; and a hydrodynamic bearing assembly having a portion thereof fitted and fixed to the mounting part, wherein any one of the mounting part and the hydrodynamic bearing assembly includes a welding reinforcing protrusion protruding from a lowest portion thereof in an axial direction in a portion in which the mounting part and the hydrodynamic bearing assembly face each other, in a direction toward the other of the mounting part and the hydrodynamic bearing assembly, and overlapping the other thereof in the axial direction, and the mounting part and the hydrodynamic bearing assembly may be coupled to each other by lap welding in the axial direction through the welding reinforcing protrusion.

The mounting part may face a sleeve of the hydrodynamic bearing assembly.

The welding reinforcing protrusion may be a first welding reinforcing protrusion protruding from the mounting part in a direction toward the sleeve.

The lowest portion of the sleeve in the axial direction may be provided with a first seating groove in which the first welding reinforcing protrusion is fitted.

The welding reinforcing protrusion may be a second welding reinforcing protrusion protruding from the sleeve in a direction toward the mounting part.

The lowest portion of the mounting part in the axial direction may be provided with a second seating groove in which the second welding reinforcing protrusion is fitted.

The mounting part faces a housing of the hydrodynamic bearing assembly, the housing having a sleeve fitted therein.

The welding reinforcing protrusion may be a third welding reinforcing protrusion protruding from the mounting part in a direction toward the housing.

The lowest portion of the housing in the axial direction may be provided with a third seating groove in which the third welding reinforcing protrusion is fitted.

The welding reinforcing protrusion may be a fourth welding reinforcing protrusion protruding from the housing in a direction toward the mounting part.

The lowest portion of the mounting part in the axial direction may be provided with a fourth seating groove in which the fourth welding reinforcing protrusion is fitted.

The lap welding may be continuously provided along the portion in which the mounting part and the hydrodynamic bearing assembly face each other in a circumferential direction.

The lap welding may be provided as spot welding in which welding parts are spaced apart from each other by predetermined intervals along the portion in which the mounting part and the hydrodynamic bearing assembly face each other in a circumferential direction

At least one portion in the portion in which the mounting part and the hydrodynamic bearing assembly face each other may be provided by bonding coupling using an adhesive.

According to another aspect of the present invention, there is provided a spindle motor, including: a base member including a mounting part; and a hydrodynamic bearing assembly having a portion thereof fitted and fixed to the mounting part, wherein a lowest portion in an axial direction in a portion in which the mounting part and the hydrodynamic bearing assembly face each other is provided with a welding reinforcing piece overlapping the mounting part and the hydrodynamic bearing assembly in the axial direction, and the mounting part and the hydrodynamic bearing assembly are coupled to each other by lap welding in the axial direction through the welding reinforcing piece.

The welding reinforcing piece may be continuously provided along the portion in which the mounting part and the hydrodynamic bearing assembly face each other in a circumferential direction.

The lap welding may be continuously provided along the portion in which the mounting part and the hydrodynamic bearing assembly face each other in the circumferential direction.

The lap welding may be provided as spot welding in which welding parts are spaced apart from each other by predetermined intervals along the portion in which the mounting part and the hydrodynamic bearing assembly face each other in the circumferential direction.

The welding reinforcing piece may be provided such that welding parts thereof are spaced apart from each other by predetermined intervals along the portion in which the mounting part and the hydrodynamic bearing assembly face each other in a circumferential direction, and the lap welding may be provided as spot welding on a portion in which the welding reinforcing piece is disposed in the circumferential direction.

At least one portion in the portion in which the mounting part and the hydrodynamic bearing assembly face each other may be provided by bonding coupling using an adhesive.

The mounting part may face a sleeve of the hydrodynamic bearing assembly.

The mounting part may face a housing of the hydrodynamic bearing assembly, the housing having a sleeve fitted therein.

According to another aspect of the present invention, there is provided a hard disk drive, including: the spindle motor as described above having power applied thereto through a substrate to rotate a disk; a magnetic head writing data to the disk and reading data from the disk; and a head transfer unit transferring the magnetic head to a predetermined position above the disk.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view illustrating a spindle motor according to an embodiment of the present invention;

FIGS. 2A through 2D are enlarged views illustrating various embodiments of portion “A” of FIG. 1;

FIG. 3 is a cross-sectional view illustrating a spindle motor according to another embodiment of the present invention;

FIGS. 4A through 4D are enlarged views illustrating various embodiments of portion “B” of FIG. 3;

FIGS. 5 and 6 are cross-sectional views illustrating a spindle motor according to another embodiment of the present invention;

FIGS. 7A and 7B are reference views illustrating an appearance in which lap welding according to the embodiment of the present invention is performed and a formation example of a welding bead formed by the lap welding; and

FIG. 8 is a schematic cross-sectional view of a disk driving device using the spindle motor according to the embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

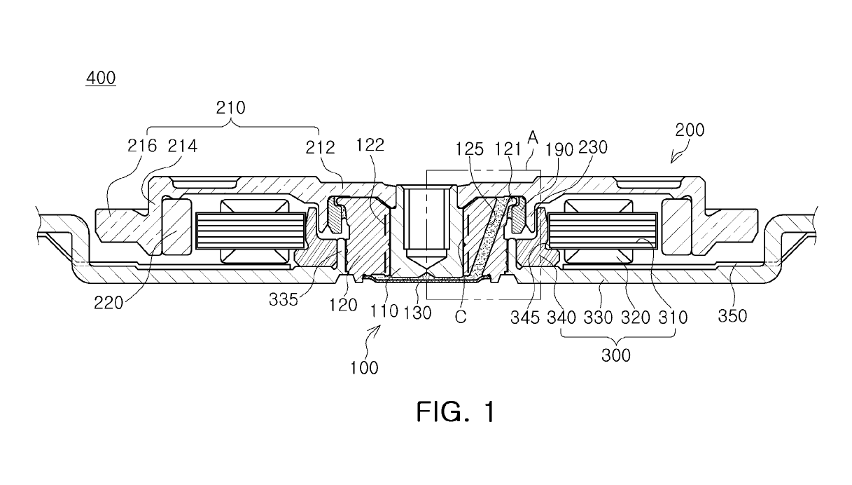

FIG. 1 is a cross-sectional view of a spindle motor according to the embodiment of the present invention.

Referring to FIG. 1, a spindle motor 400 according to an embodiment of the present invention may include a hydrodynamic bearing assembly 100 including a shaft 110 and a sleeve 120, a rotor 200 including a hub 210, and a stator 300 including a core 310 with a coil 320 wound therearound.

The hydrodynamic bearing assembly 100 may include the shaft 110, the sleeve 120, a stopper 190, and the hub 210 and in this case, the hub 210, a component configuring the rotor 200 to be described below, may also be a component configuring the hydrodynamic bearing assembly 100.

Terms with respect to directions will first be defined. As illustrated in FIG. 1, an axial direction refers to a vertical direction based on the shaft 110, and an outer diameter direction or inner diameter direction may refer to a direction toward an outer edge of the hub 210 based on the shaft 110 or a direction toward a center of the shaft 110 based on the outer edge of the hub 210. In addition, a circumferential direction may refer to a direction in which the rotor 200 rotates from a predetermined point in the outer diameter direction, based on the shaft 110.

Further, in the following description, rotating members may include the shaft 110, the rotor 200 including the hub 210, a magnet 220 mounted on the rotor 200, and the like, and fixed members may be relatively fixed to the rotating members and include the sleeve 120, the stator 300, a base member 330, and the like, other than the rotating members.

The sleeve 120 may support the shaft 110 so that an upper end of the shaft 110 protrudes upwardly in the axial direction. The sleeve 120 may be formed by forging Cu or Al or sintering a Cu—Fe-based alloy powder or a SUS-based powder. In addition, the sleeve 120 may be manufactured using various materials commonly known in the art without being limited thereto.

In this configuration, the shaft 110 may be inserted into a shaft hole of the sleeve 120 to have a micro clearance serving as a bearing clearance C between the shaft 110 and the shaft hole of the sleeve 120. The bearing clearance may be filled with oil, and a rotation of the rotor 200 may be smoothly supported by a radial dynamic pressure groove 122 formed in at least one of an outer diameter portion of the shaft 110 and an inner side surface of the sleeve 120.

The radial dynamic pressure groove 122 may be formed in the inner side surface of the sleeve 120, which is an inner portion of the shaft hole of the sleeve 120, and generate pressure so that the shaft 110 may rotate in a state in which the shaft 111 is spaced apart from the sleeve 110 by a predetermined interval at the time of the rotation of the shaft 110.

However, the radial dynamic pressure grooves 122 are not limited to being formed in the inner side surface of the sleeve 120 as described above, but may also be formed in the outer diameter portion of the shaft 110. Here, the number of radial dynamic pressure grooves 122 is not limited.

The radial dynamic pressure grooves 122 may have any one of a herringbone shape, a spiral shape, and a helix shape. However, the radial dynamic pressure grooves 122 may have any shape as long as radial dynamic pressure may be generated thereby.

The sleeve 120 may be provided with a circulation hole 125 that allows upper and lower portions of the sleeve 120 to be in communication with each other. The circulation hole 125 may disperse pressure in oil in the hydrodynamic bearing assembly 100 to maintain balance in the pressure of the oil and may circulate air bubbles, and the like, present in the hydrodynamic bearing assembly 100 and discharge the air bubbles.

Here, an upper end of the sleeve 120 may be provided with a projection 121 protruding in the outer diameter direction to allow the stopper 190 to be locked, thereby limiting floating of the shaft 110 and the rotor 200.

Further, the sleeve 120 may have a cover member 130 coupled to a lower portion thereof in the axial direction, having a clearance therebetween, and in this case, the clearance receives the oil.

The cover member 130 may receive the oil in the clearance between the cover member 130 and the sleeve 120, thereby serving as a bearing supporting a lower surface of the shaft 110.

The hub 210, which is a rotating member coupled to the shaft 110 and rotating together with the shaft 110, may be a component configuring the rotor 200 while serving as a component configuring the hydrodynamic bearing assembly 100. Hereinafter, the rotor 200 will be described in detail.

The rotor 200 may be a rotating structure rotatably disposed with respect to the stator 300 and include the hub 210 having an annular ring-shaped magnet 220 disposed on an outer circumferential surface thereof, wherein the annular ring-shaped magnet 220 corresponds to the core 310 to be described below, having a predetermined interval therebetween.

In other words, the hub 210 may be a rotating member which is coupled to the shaft 110 to rotate together with the shaft 110.

Here, as the magnet 220, a permanent magnet generating a magnetic force having a predetermined strength by alternately magnetizing an N pole and an S pole thereof in the circumferential direction may be used.

Further, the hub 210 may include a disk part 212 that is fixed to the upper end of the shaft 110 and extends in a radial direction and a cylindrical wall part 214 that protrudes downwardly from an end of the disk part 212 in the outer diameter direction and an inner circumferential surface of the cylindrical wall part 214 may be coupled to the magnet 220. Further, the hub 210 may include a disk seating part 216 that extends in the outer diameter direction from the lower end of the cylindrical wall part 214 in the axial direction to have a disk seated thereon.

The hub 210 may have a wall part 230 extending downwardly in the axial direction so as to correspond to an outer upper portion of the sleeve 120.

Here, the wall part 230 may include the stopper 190 disposed at an inner side thereof, wherein the stopper 190 is locked to the projection 121 protruding from the upper end of the sleeve 120 in the outer diameter direction to limit floating of the hub 210 and forms an oil interface between an inner surface thereof in the inner diameter direction and an outer surface of the sleeve 120.

In addition, an inner circumferential surface of the stopper 190 may be tapered, such that an interval between the inner circumferential surface of the stopper 190 and the outer surface of the sleeve 120 becomes wider downwardly in the axial direction, thereby facilitating sealing of the oil. Further, an outer circumferential surface of the sleeve 120 may also be tapered to facilitate the sealing of the oil.

Meanwhile, the wall part 230 may have a stepped part 231 on which the stopper 190 is seated.

The stator 300 may include the coil 320, the core 310, the base member 330, and a core mounting part 340.

In other words, the stator 300 may be a fixed structure that includes the coil 320 generating electromagnetic force having a predetermined magnitude at the time of the application of power thereto, and a plurality of cores 310 having the coil 320 wound therearound.

The core 310 may be fixedly disposed on an upper portion of the base member 330 including a printed circuit board 350 having pattern circuits printed thereon, an upper surface of base member 330 corresponding to the winding coil 320 may be provided with a plurality of coil holes having a predetermined size and penetrating through the base member 330 so as to expose the winding coil 320 downwardly, and the winding coil 320 may be electrically connected to the printed circuit board 350 so that external power may be supplied thereto.

The base member 330 may be formed by plastic working a steel plate. Further, the base member 330 may be manufactured using various materials commonly known in the art without being limited thereto.

The base member 330 may be fixed to the outer circumferential surface of the sleeve 120 and have the core 310 inserted therein, wherein the core 330 has the coil 320 wound therearound.

Here, the base member 330 may include a mounting part 335. The mounting part 335 may protrude from the base member 330 upwardly in the axial direction and a portion of the hydrodynamic bearing assembly 100 may be fitted and fixed to the mounting part 335. In more detail, the mounting part 335 may have the sleeve 120 fitted and fixed thereto.

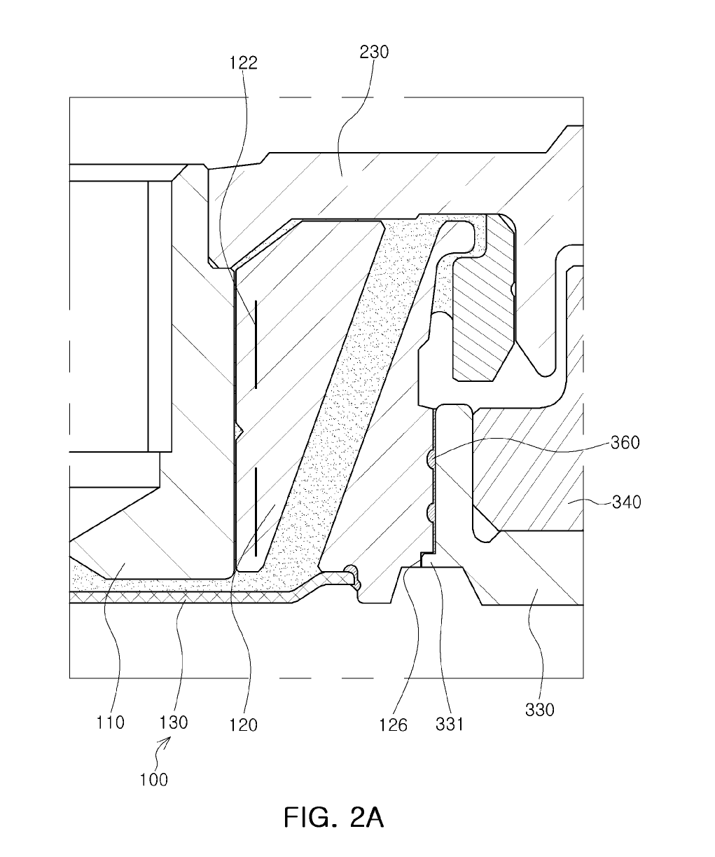

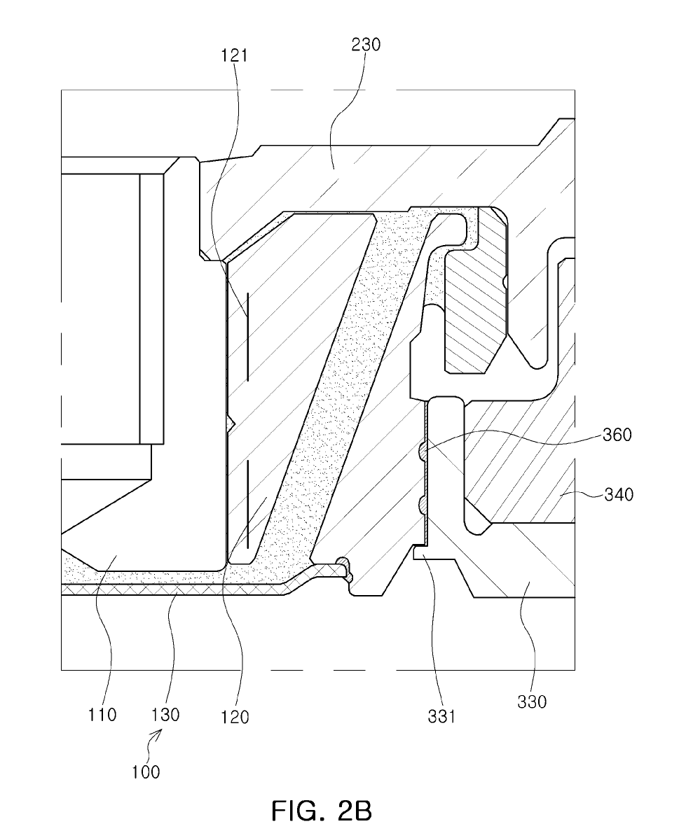

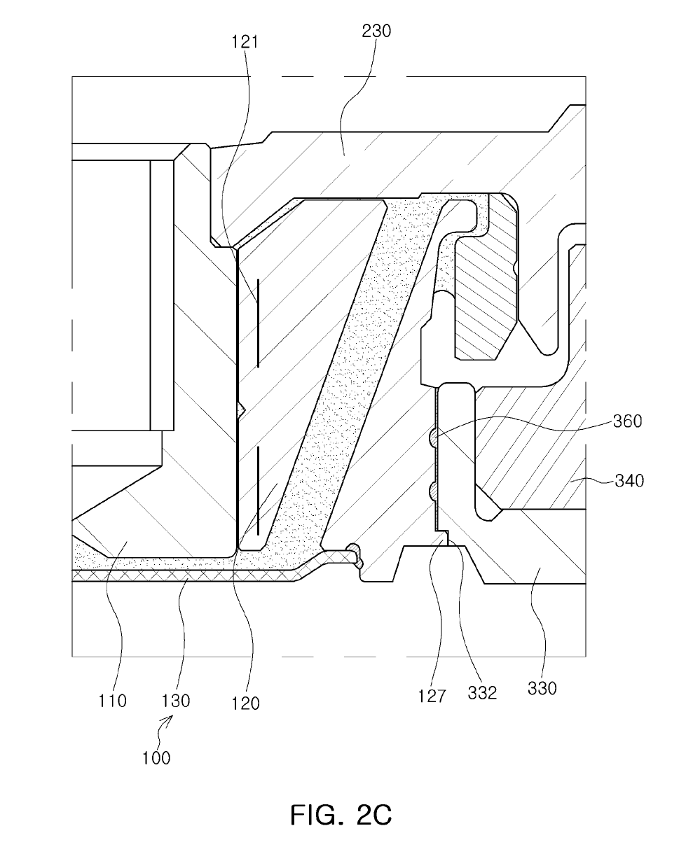

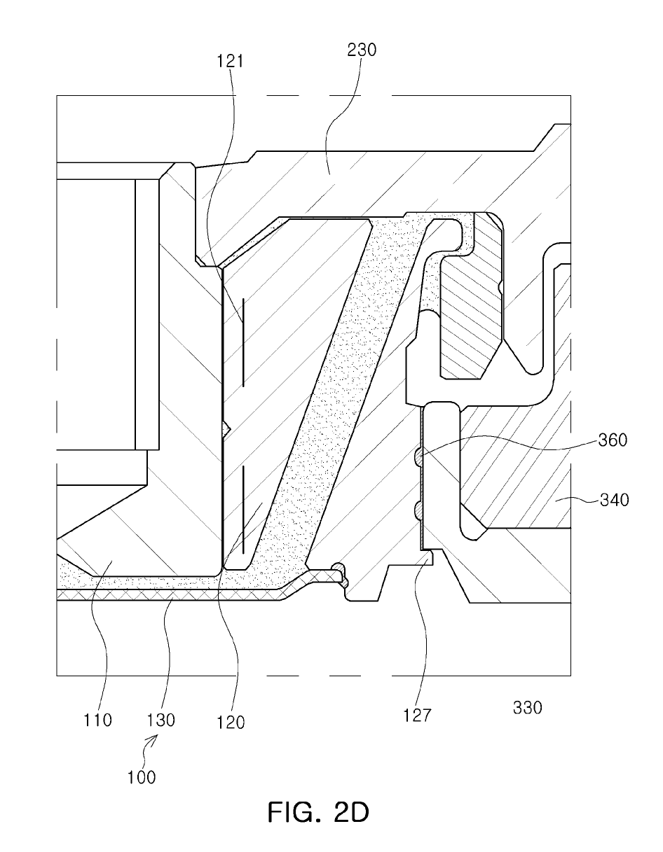

Here, the mounting part 335 of the base member 330 and the sleeve 120 may be slidably coupled or fitted to each other. In this case, an adhesive 360 may be interposed between the mounting part 335 and the sleeve 120 to bond the mounting part 335 to the sleeve 120. In addition, the lowest portions of the mount part 335 and the sleeve 120 in the axial direction may be coupled to each other by lap welding. This will be described with reference to FIGS. 2A through 2D.

The core mounting part 340 may be mounted on the base member 330 to mount the stator core 310 around which the coil 320 is wound thereon. An inner side surface of the core mounting part 340 may be slidably coupled or fitted and fixed to the mounting part 335 of the base member 330. Further, the adhesive may be interposed between the core mounting part 340 and the mounting part 335 to bond the core mounting part 340 to the mounting part 335.

A side surface of the core mounting part 340 in the outer diameter direction is provided with a stepped jaw part 345, such that the stator core 310 may be fitted and fixed to the stepped jaw part 345. A position of the stator core 310 in the axial direction may be accurately fixed by the stepped jaw part 345.

FIGS. 2A through 2D are enlarged views illustrating various embodiments of portion “A” of FIG. 1. For convenience, FIG. 1 is illustrated as the drawing corresponding to an enlarged view of FIG. 2A, which corresponds to one embodiment of the present invention and portion “A” may be configured in various embodiments to be described below.

In the spindle motor 400 according to the embodiment of the present invention, a configuration in which the hydrodynamic bearing assembly 100 is fixed to the base member 330 will be described with reference to FIGS. 2A through 2D.

In the spindle motor 400 according to the embodiment of the present invention, any one of the mounting part 335 of the base member 330 and the hydrodynamic bearing assembly 100 includes a welding reinforcing protrusion 331 or 127 protruding from a lowest portion thereof in the axial direction in a portion in which the mounting part 335 and the hydrodynamic bearing assembly 100 face each other, in a direction toward the other of the mounting part 335 and the hydrodynamic bearing assembly 100, and overlapping the other thereof in the axial direction, wherein the mounting part 335 and the hydrodynamic bearing assembly 100 may be coupled to each other by lap welding in the axial direction through the welding reinforcing protrusion 331 or 127. Hereinafter, each case will be described in detail.

Referring to FIGS. 2A and 2B, the base member 330 of the spindle motor 400 according to the embodiment of the present invention may be provided with the first welding reinforcing protrusion 331 that is disposed at a lower end thereof in the axial direction to protrude in the inner diameter direction. The first welding reinforcing protrusion 331 may extend to a lower portion of the hydrodynamic bearing assembly 100 facing the mounting part 335. That is, according to the embodiment of the present invention, the first welding reinforcing protrusion 331 may extend in the inner diameter direction along a lower surface of the sleeve 120 in the axial direction, the sleeve 120 configuring the hydrodynamic bearing assembly 100 facing the mounting part 335.

In this case, the lowest portion of the sleeve 120 in the axial direction may be provided with a first seating groove 126 in which the first welding reinforcing protrusion 331 is fitted (see FIG. 2A). In addition, the first welding reinforcing protrusion 331 may simply extend to the lower portion of the sleeve 120 (see FIG. 2B).

Here, the first welding reinforcing protrusion 331 may be formed in a continuous manner in the circumferential direction or the first welding reinforcing protrusions 331 may be repeatedly disposed, while being spaced apart from each other by predetermined intervals in the circumferential direction. Further, the first seating groove 126 may be appropriately formed to correspond to a dispositional shape of the first welding reinforcing protrusion 331.

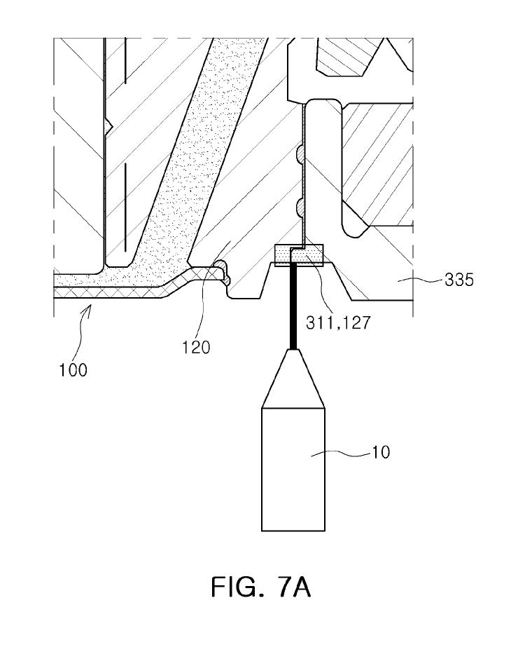

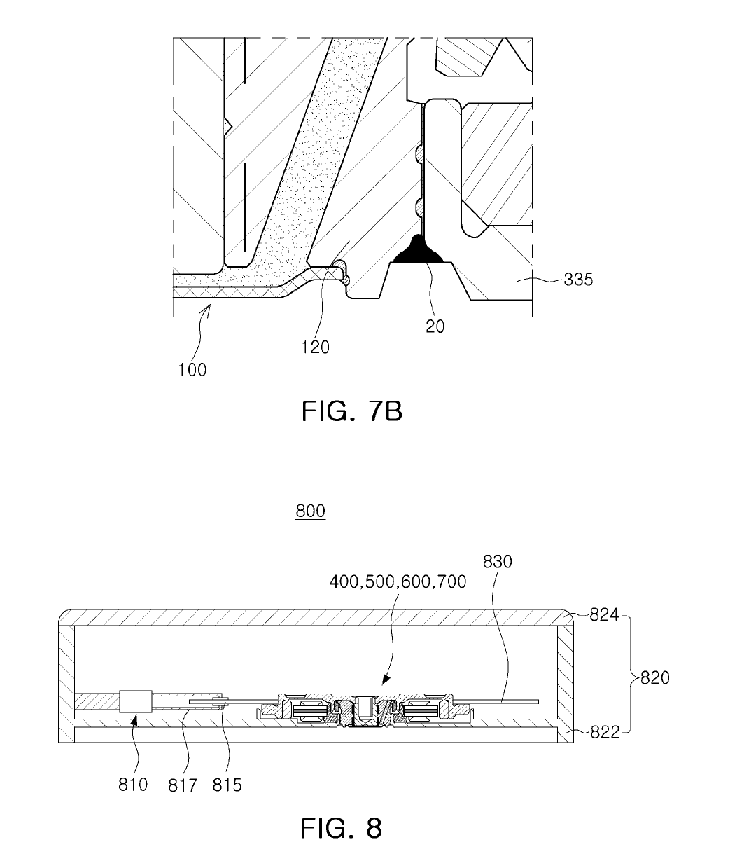

When the sleeve 120 and the base member 330 are disposed in the above manner, the first welding reinforcing protrusion 331 may be provided with a region in which the first welding reinforcing protrusion 331 overlaps the sleeve 120 in the axial direction. Therefore, the overlapping region may be lap welded by laser welding using a laser welding machine 10 to form a welding bead 20 integrally welding three members including the first welding reinforcing protrusion 331, the sleeve 120, and the mounting part 335 in the axial direction (see FIGS. 7A and 7B). The welding bead 20 may be integrally formed after melting the first welding reinforcing protrusion 331, the sleeve 120, and the mounting part 335 through laser welding.

Meanwhile, the lap welding may be continuously provided or may be provided as spot welding in which welding parts are spaced apart from each other by predetermined intervals along the portion in which the mounting part 335 and the hydrodynamic bearing assembly 100, more specifically, the sleeve 120, face each other, in the circumferential direction.

Next, referring to FIGS. 2C and 2D, the hydrodynamic bearing assembly 100, more specifically, the sleeve 120 of the spindle motor 400 according to the embodiment of the present invention may be provided with the second welding reinforcing protrusion 127 that is disposed at a lower end thereof in the axial direction so as to protrude in the outer diameter direction. The second welding reinforcing protrusion 127 may extend to the lower portion of the base member 330, more specifically, the mounting part 335 facing the sleeve 120. That is, according to the embodiment of the present invention, the second welding reinforcing protrusion 127 may extend in the outer diameter direction along a lower surface of the mounting part 335 in the axial direction, the mounting part 335 facing the sleeve 120.

In this case, the lowest portion of the mounting part 335 in the axial direction may be provided with a second seating groove 332 in which the second welding reinforcing protrusion 127 is fitted (see FIG. 2C). In addition, the second welding reinforcing protrusion 127 may simply extend to the lower portion of the mounting part 335 (see FIG. 2D).

Here, the second welding reinforcing protrusion 127 may be formed in a continuous manner in the circumferential direction or the second welding reinforcing protrusions 127 may be repeatedly disposed, while being spaced apart from each other by predetermined intervals in the circumferential direction. Further, the second seating groove 332 may be appropriately formed to correspond to a dispositional shape of the second welding reinforcing protrusion 127.

When the sleeve 120 and the base member 330 are disposed in the above manner, the second welding reinforcing protrusion 127 may be provided with a region in which the second welding reinforcing protrusion 331 overlaps the mounting part 335 in the axial direction. Therefore, the overlapping region may be lap welded by laser welding using the laser welding machine 10 to form the welding bead 20 integrally welding three members including the second welding reinforcing protrusion 127, the sleeve 120, and the mounting part 335 in the axial direction (see FIGS. 7A and 7B). The welding bead 20 may be integrally formed after melting the second welding reinforcing protrusion 127, the sleeve 120, and the mounting part 335 through laser welding.

Meanwhile, the lap welding may be continuously provided or may be provided as spot welding in which welding parts are spaced apart from each other by predetermined intervals along the portion in which the mounting part 335 and the hydrodynamic bearing assembly 100, more specifically, the sleeve 120, face each other, in the circumferential direction.

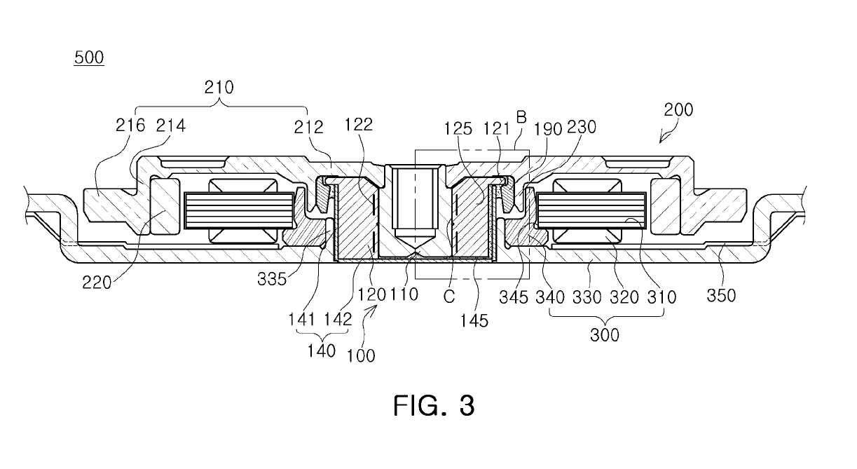

FIG. 3 is a cross-sectional view of a spindle motor according to another embodiment of the present invention.

When comparing a spindle motor 500 according to the embodiment of FIG. 3 with the spindle motor 400 according to the foregoing embodiment of the present invention, the spindle motor 500 is different from the spindle motor 400 in that the spindle motor 500 further includes a housing 140 having the sleeve 120 fitted therein and fitted to the base member 330 and has the circulation hole disposed between the sleeve 120 and the housing 140. Hereinafter, portions of the spindle motor 500 different from those of the spindle motor 400 according to the foregoing embodiment of the present invention will mainly be described and detailed descriptions of components denoted by the same reference numerals will be omitted.

The spindle motor 500 according to another embodiment of the present invention may include the hydrodynamic bearing assembly 100 including the shaft 110, the sleeve 120, and the housing 140, the rotor 200 including the hub 210, and the stator 300 including the core 310 having the coil 320 wound therearound.

The hydrodynamic bearing assembly 100 may include the shaft 110, the sleeve 120, the cover member 130, the housing 140, the stopper 190, and the hub 210 and in this case, the hub 210, a component configuring the rotor 200, may also be a component configuring the hydrodynamic bearing assembly 100.

Further, in the following description, the rotating members may include the shaft 110, the rotor 200 including the hub 210, the magnet 220 mounted on the rotor 200, and the like, and the fixed members may be relatively fixed to the rotating members and include the sleeve 120, the housing 140, the stator 300, the base member 330, and the like.

The housing 140 is provided to have a cup shape and may have the sleeve 120 fitted therein. The housing 140 may be formed by plastic working a steel plate and may also be formed by forging Cu or Al. In addition, the housing 140 may be manufactured using various materials commonly known in the art without being limited thereto.

A circulation hole 145 formed to be in communication with the upper and lower portions of the sleeve 120 may be disposed between the housing 140 and the sleeve 120. In this case, the circulation hole 145 may be a groove disposed along the inner surface of the housing 140. In addition, the circulation hole 145 may be a groove disposed along the outer surface of the sleeve 120.

Meanwhile, the embodiment of the present invention illustrates a structure in which a side plate 141 and a bottom plate 142 of the housing 140 are integrally disposed, but is not limited thereto, and therefore the side plate 141 and the bottom plate 142 may be separately disposed from each other and be coupled to each other by an adhesive bonding, a welding coupling, or the like.

Further, an inner side surface of the stopper 190, disposed in the inner side of the wall part 230, may form an oil interface between the inner side surface of the stopper 190 and an outer side surface of the housing 140.

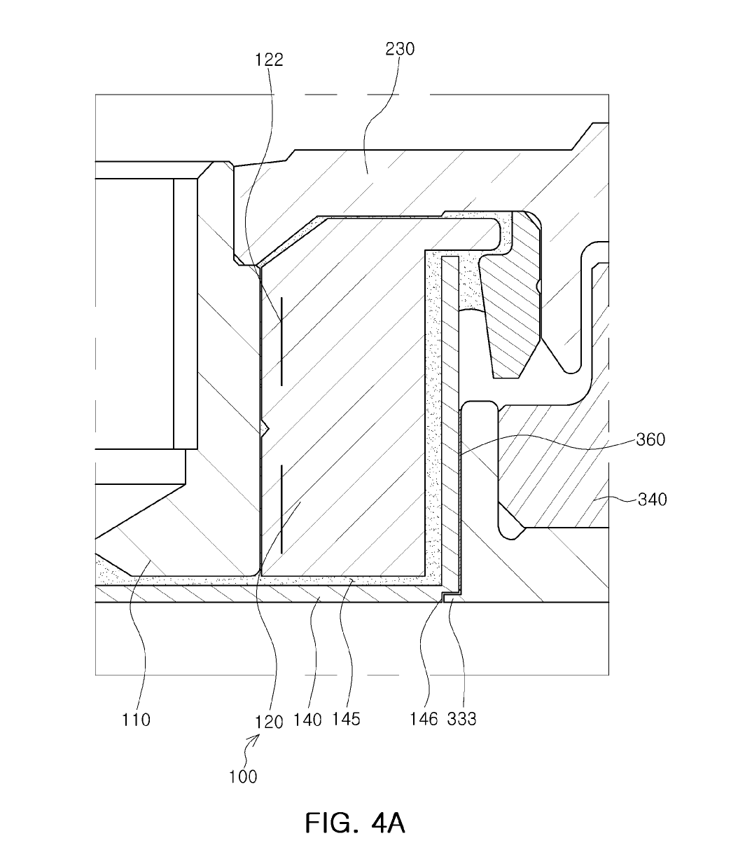

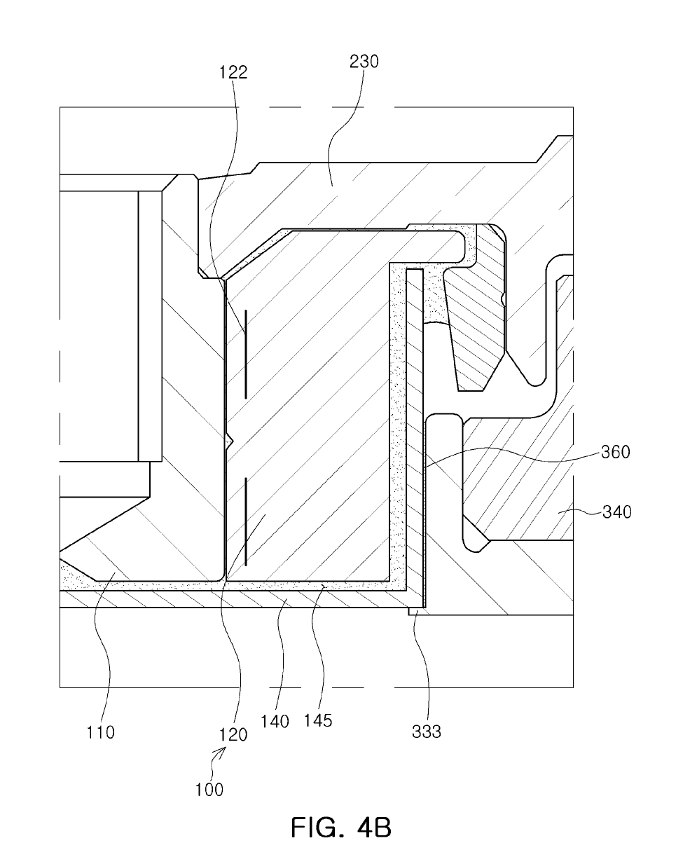

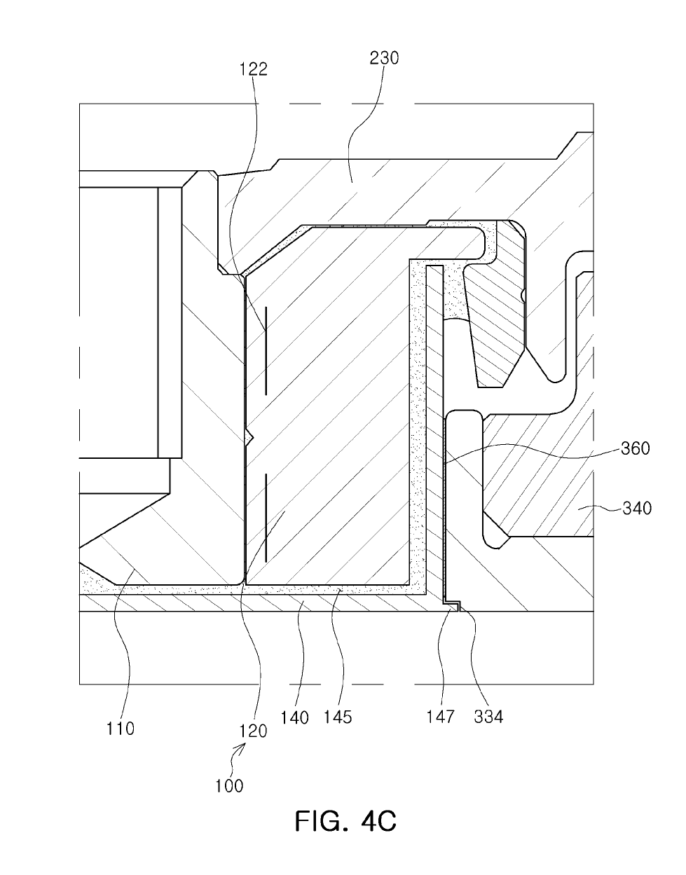

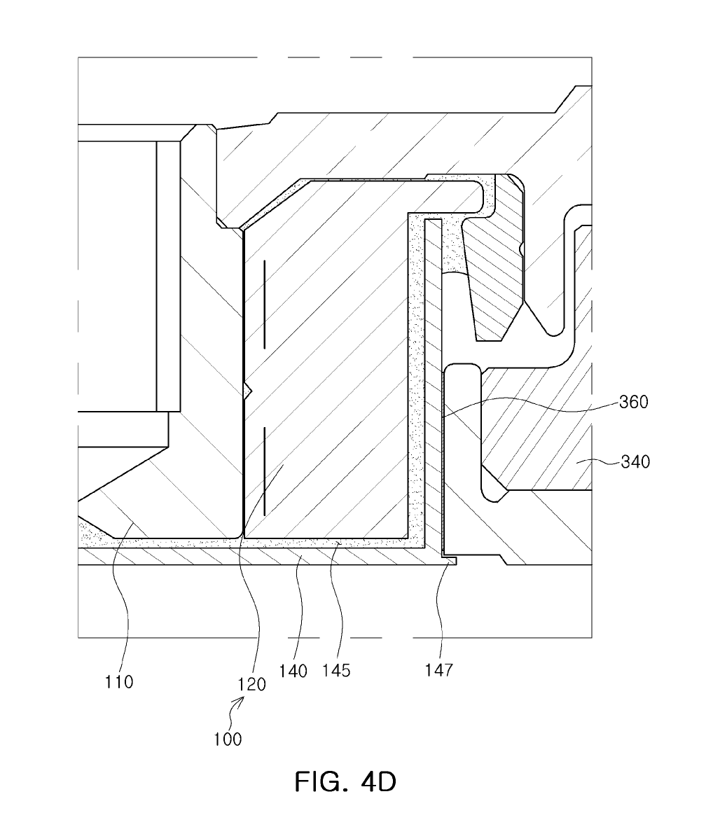

FIGS. 4A through 4D are enlarged views illustrating various embodiments of portion “B” of FIG. 3. For reference, an enlarged view of portion “B” is illustrated in FIG. 4A, but is merely provided by way of example in an embodiment and portion “B” may be configured in various embodiments to be described below.

In the spindle motor 500 according to the embodiment of the present invention, a configuration in which the hydrodynamic bearing assembly 100 is fixed to the base member 330 will be described with reference to FIGS. 4A through 4D.

In the spindle motor 500 according to the embodiment of the present invention, any one of the mounting part 335 of the base member 330 and the hydrodynamic bearing assembly 100 includes a welding reinforcing protrusion 333 or 147 protruding from a lowest portion thereof in the axial direction in a portion in which the mounting part 335 and the hydrodynamic bearing assembly 100 face each other, in a direction toward the other of the mounting part 335 and the hydrodynamic bearing assembly 100, and overlapping the other thereof in the axial direction, wherein the mounting part 335 and the hydrodynamic bearing assembly 100 may be coupled to each other by lap welding in the axial direction through the welding reinforcing protrusion 333 or 147. Hereinafter, each case will be described in detail.

Referring to FIGS. 4A and 4B, the base member 330 of the spindle motor 500 according to the embodiment of the present invention may be provided with the third welding reinforcing protrusion 333 that is disposed at a lower end thereof in the axial direction to protrude in the inner diameter direction. The third welding reinforcing protrusion 333 may extend to the lower portion of the hydrodynamic bearing assembly 100 facing the mounting part 335. That is, according to the embodiment of the present invention, the third welding reinforcing protrusion 333 may extend in the inner diameter direction along a lower surface of the housing 140 in the axial direction, the housing 140 configuring the hydrodynamic bearing assembly 100 facing the mounting part 335.

In this case, the lowest portion of the housing 140 in the axial direction may be provided with a third seating groove 146 in which the third welding reinforcing protrusion 333 is fitted (see FIG. 4A). In addition, the third welding reinforcing protrusion 333 may simply extend to the lower portion of the housing 140 (see FIG. 4B).

Here, the third welding reinforcing protrusion 333 may be formed in a continuous manner in the circumferential direction or the third welding reinforcing protrusions 333 may be repeatedly disposed, while being spaced apart from each other by predetermined intervals in the circumferential direction. Further, the third seating groove 146 may be appropriately formed to correspond to a dispositional shape of the third welding reinforcing protrusion 333.

When the housing 140 and the base member 330 are disposed in the above manner, the third welding reinforcing protrusion 333 may be provided with a region in which the third welding reinforcing protrusion 333 overlaps the housing 140 in the axial direction. Therefore, the overlapping region may be lap welded by laser welding using the laser welding machine 10 to form the welding bead 20 integrally welding three members including three members including the third welding reinforcing protrusion 333, the housing 140, and the mounting part 335 in the axial direction (see FIGS. 7A and 7B, in FIGS. 7A and 7B, the members are merely different from those of the present embodiment in terms of the coupling shape between the sleeve and the mounting part but the laser welding method is identical). The welding bead 20 may be integrally formed after melting the third welding reinforcing protrusion 333, the housing 140, and the mounting part 335 through laser welding.

Meanwhile, the lap welding may be continuously provided or may be provided as spot welding in which welding parts are spaced apart from each other by predetermined intervals along the portion in which the mounting part 335 and the hydrodynamic bearing assembly 100, more specifically, the housing 140, face each other, in the circumferential direction.

Next, referring to FIGS. 4C and 4D, the hydrodynamic bearing assembly 100, more specifically, the housing 140 of the spindle motor 500 according to the embodiment of the present invention may be provided with the fourth welding reinforcing protrusion 147 that is disposed at a lower end thereof in the axial direction so as to protrude in the outer diameter direction. The fourth welding reinforcing protrusion 147 may extend to the lower portion of the base member 330, more specifically, the mounting part 335 facing the housing 140. That is, according to the embodiment of the present invention, the fourth welding reinforcing protrusion 147 may extend in the outer diameter direction along the lower surface of the mounting part 335 in the axial direction, the mounting part 335 facing the housing 140.

In this case, the lowest portion of the mounting part 335 in the axial direction may be provided with a fourth seating groove 334 in which the fourth welding reinforcing protrusion 147 is fitted (see FIG. 4C). In addition, the fourth welding reinforcing protrusion 147 may simply extend to the lower portion of the mounting part 335 (see FIG. 4D).

Here, the fourth welding reinforcing protrusion 147 may be formed in a continuous manner in the circumferential direction or the fourth welding reinforcing protrusions 147 may be repeatedly disposed, being spaced apart from each other by predetermined intervals in the circumferential direction. Further, the fourth seating groove 334 may be appropriately formed, corresponding to a disposition shape of the fourth welding reinforcing protrusion 147.

When the housing 140 and the base member 330 are disposed in the above manner, the fourth welding reinforcing protrusion 147 may be provided with a region in which the fourth welding reinforcing protrusion 147 overlaps the mounting part 335 in the axial direction. Therefore, the overlapping region may be lap welded by laser welding using the laser welding machine 10 to form the welding bead 20 integrally welding three members including the fourth welding reinforcing protrusion 147, the housing 140, and the mounting part 335 in the axial direction (see FIGS. 7A and 7B, in FIGS. 7A and 7B, the members are merely different from those of the present embodiment in terms of the coupling shape between the sleeve and the mounting part but the laser welding method is identical). The welding bead 20 may be integrally formed after melting the fourth welding reinforcing protrusion 147, the housing 140, and the mounting part 335 through laser welding.

Meanwhile, the lap welding may be continuously provided in the circumferential direction or may be provided as spot welding in which welding parts are spaced apart from each other by predetermined intervals along the portion in which the mounting part 335 and the hydrodynamic bearing assembly 100, more specifically, the housing 140, face each other, in the circumferential direction.

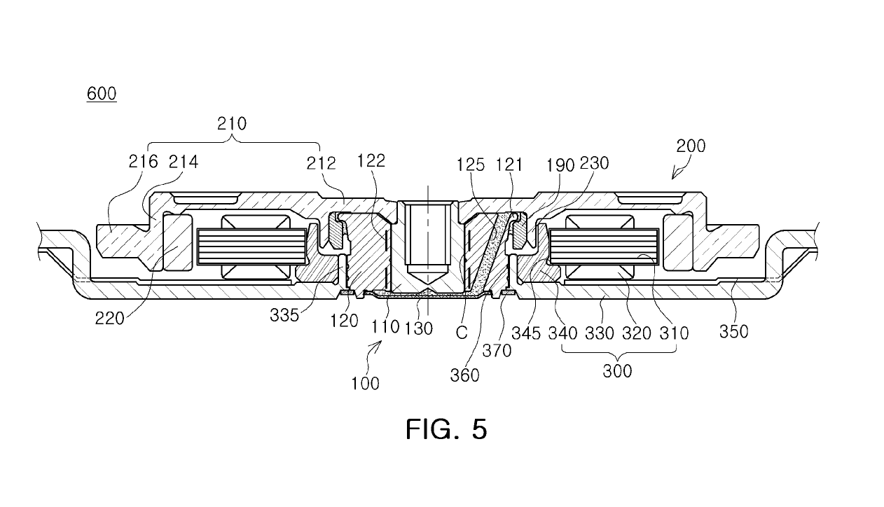

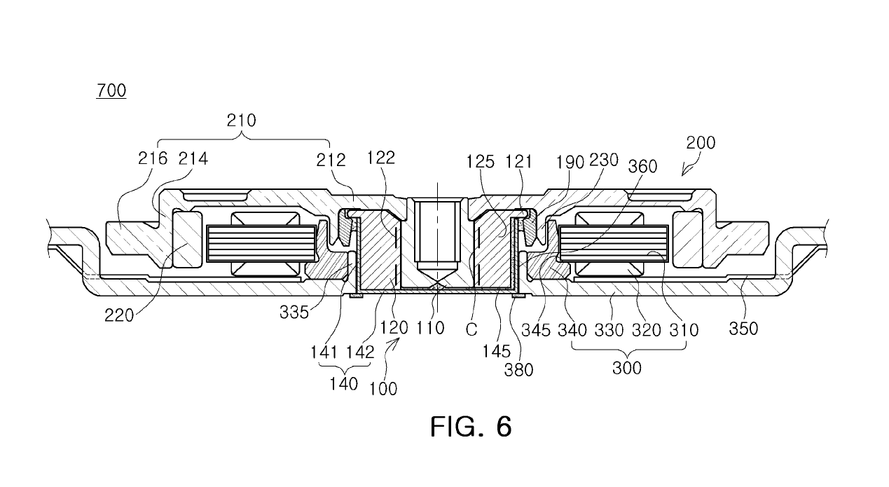

FIGS. 5 and 6 are cross-sectional views illustrating a spindle motor according to another embodiment of the present invention.

When comparing a spindle motor 600 according to another embodiment of the present invention with the spindle motor 400 according to the foregoing embodiment of the present invention, the spindle motor 600 is different from the spindle motor 400 in that the lap welding is performed using a separate welding reinforcing piece, rather than using the welding reinforcing protrusion, and other structures thereof are the same as those of the spindle motor 400.

When comparing a spindle motor 700 according to another embodiment of FIG. 6 with the spindle motor 500 according to another embodiment of the present invention, the spindle motor 700 is different from the spindle motor 500 in that the lap welding is performed using another separate welding reinforcing piece, rather than using the welding reinforcing protrusion, and other structures thereof are the same as those of the spindle motor 500.

Hereinafter, portions different from those of the spindle motor 400 according to the foregoing embodiment of the present invention or those of the spindle motor 500 according to another embodiment of the present invention are mainly described and the same components are denoted by the same reference numerals and the detailed description thereof will be omitted.

Referring to FIG. 5, the spindle motor 600 according to another embodiment of the present invention may include the hydrodynamic bearing assembly 100 including the shaft 110 and the sleeve 120, the rotor 200 including the hub 210, and the stator 300 including the core 310 having the coil 320 wound therearound.

The hydrodynamic bearing assembly 100 may include the shaft 110, the sleeve 120, the stopper 190, and the hub 210 and in this case, the hub 210, a component configuring the rotor 200, may also be a component configuring the hydrodynamic bearing assembly 100.

In the spindle motor 600 according to another embodiment of the present invention, the configuration in which the hydrodynamic bearing assembly 100 is fixed to the base member 330 will be described with reference to FIG. 5.

The spindle motor 600 according to another embodiment of the present invention may include a welding reinforcing piece 370 overlapping the mounting part 335 and the hydrodynamic bearing assembly 100 in the axial direction, in a lowest portion thereof in the axial direction in a portion in which the mounting part 335 of the base member 330 and the hydrodynamic bearing assembly 100, more specifically, the sleeve 120, face each other, wherein the mounting part 335 and the hydrodynamic bearing assembly 100 may be coupled to each other by the lap welding in the axial direction through the welding reinforcing piece 370.

Meanwhile, the welding reinforcing piece 370 may be formed in a continuous manner or the welding reinforcing pieces 370 may be spaced apart from each other by predetermined intervals along the portion in which the mounting part 335 and the hydrodynamic bearing assembly 100, more specifically, the sleeve 120, face each other, in the circumferential direction.

When the sleeve 120 and the base member 330 are disposed in the above manner, the welding reinforcing piece 370 may be provided with a region in which the welding reinforcing piece 370 overlaps the sleeve 120 and the mounting part 335 in the axial direction. Therefore, the overlapping region may be lap welded by laser welding using the laser welding machine 10 to form the welding bead 20 integrally welding three members including the welding reinforcing piece 370, the sleeve 120, and the mounting part 335 in the axial direction (see FIGS. 7A and 7B, in FIGS. 7A and 7B, the members are merely different from those of the present embodiment in terms of the coupling shape between the sleeve including the welding reinforcing protrusion and the mounting part but the laser welding method is identical). The welding bead 20 may be integrally formed after melting the welding reinforcing piece 370, the sleeve 120, and the mounting part 335 through laser welding.

Meanwhile, the lap welding may be continuously provided in the circumferential direction or may be provided as spot welding in which welding parts are spaced apart from each other by predetermined intervals along the portion in which the mounting part 335 and the hydrodynamic bearing assembly 100, more specifically, the sleeve 120, face each other, in the circumferential direction.

Referring to FIG. 6, the spindle motor 700 according to another embodiment of the present invention may include the hydrodynamic bearing assembly 100 including the shaft 110, the sleeve 120, and the housing 140, the rotor 200 including the hub 210, and the stator 300 including the core 310 having the coil 320 wound therearound.

The hydrodynamic bearing assembly 100 may include the shaft 110, the sleeve 120, the housing 140, the stopper 190, and the hub 210 and in this case, the hub 210, a component configuring the rotor 200, may also be a component configuring the hydrodynamic bearing assembly 100.

In the spindle motor 700 according to another embodiment of the present invention, the configuration in which the hydrodynamic bearing assembly 100 is fixed to the base member 330 will be described with reference to FIG. 6.

The spindle motor 700 according to another embodiment of the present invention may include a welding reinforcing piece 380 overlapping the mounting part 335 and the hydrodynamic bearing assembly 100 in the axial direction, in a lowest portion thereof in the axial direction in a portion in which the mounting part 335 of the base member 330 and the hydrodynamic bearing assembly 100, more specifically, the housing 140, face each other, wherein the mounting part 335 and the hydrodynamic bearing assembly 100 may be coupled to each other by the lap welding in the axial direction through the welding reinforcing piece 380.

Here, the welding reinforcing piece 380 may be formed in a continuous manner or the welding reinforcing pieces 380 may be spaced apart from each other by predetermined intervals along the portion in which the mounting part 335 and the hydrodynamic bearing assembly 100, more specifically, the housing 140, face each other, in the circumferential direction.

When the housing 140 and the base member 330 are disposed in the above manner, the welding reinforcing piece 380 may be provided with a region in which the welding reinforcing piece 380 overlaps the housing 140 and the mounting part 335 in the axial direction. Therefore, the overlapping region may be lap welded by laser welding using the laser welding machine 10 to form the welding bead 20 integrally welding three members including the welding reinforcing piece 380, the housing 140, and the mounting part 335 in the axial direction (see FIGS. 7A and 7B, in FIGS. 7A and 7B, the members are merely different from those of the present embodiment in terms of the coupling shape between the sleeve including the welding reinforcing protrusion and the mounting part but the laser welding method is identical). The welding bead 20 may be integrally formed after melting the welding reinforcing piece 380, the housing 140, and the mounting part 335.

Meanwhile, the lap welding may be continuously provided in the circumferential direction or may be provided as spot welding in which welding parts are spaced apart from each other by predetermined intervals along the portion in which the mounting part 335 and the hydrodynamic bearing assembly 100, more specifically, the housing 140, face each other, in the circumferential direction.

Referring to FIG. 8, a recording disk driving device 800 having the spindle motor 100 according to the embodiment of the present invention mounted therein may be a hard disk driving device and include the spindle motor 100, a head transfer part 810, and a housing 820.

The spindle motor 100 has all characteristics of the motor according to the foregoing embodiment of the present invention described above and may have a recording disk 830 mounted thereon.

The head transfer part 810 may transfer a head 815 reading data from the recording disk 830 mounted on the spindle motor 100 to a surface of the recording disk of which the data is to be read.

Here, the head 815 may be disposed on a support part 817 of the head transfer part 810.

The housing 820 may include a motor mounting plate 822 and a top cover 824 shielding an upper portion of the motor mounting plate 822 in order to form an internal space receiving the spindle motor 100 and the head transfer part 810 therein.

As set forth above, according to the embodiment of the present invention, a spindle motor capable of very simply performing welding while improving unmating force between a sleeve or a holder and a base member can be provided.

Further, according to the embodiment of the present invention, welding can be very simply performed by simply controlling a relative position between the sleeve or the holder and the base member prior to performing welding bonding.

While the present invention has been shown and described in connection with the embodiments, it will be apparent to those skilled in the art that modifications and variations can be made without departing from the spirit and scope of the invention as defined by the appended claims.

What is claimed is:

1. A spindle motor, comprising:
a base member including a mounting part; and
a hydrodynamic bearing assembly having a portion thereof fitted and fixed to the mounting part,
wherein any one of the mounting part and the hydrodynamic bearing assembly includes a welding reinforcing protrusion protruding from a lowest portion thereof in an axial direction in a portion in which the mounting part and the hydrodynamic bearing assembly face each other, in a direction toward the other of the mounting part and the hydrodynamic bearing assembly, and overlapping the other thereof in the axial direction, and
the mounting part and the hydrodynamic bearing assembly may be coupled to each other by lap welding in the axial direction through the welding reinforcing protrusion.

2. The spindle motor of claim 1, wherein the mounting part faces a sleeve of the hydrodynamic bearing assembly.

3. The spindle motor of claim 2, wherein the welding reinforcing protrusion is a first welding reinforcing protrusion protruding from the mounting part in a direction toward the sleeve.

4. The spindle motor of claim 3, wherein the lowest portion of the sleeve in the axial direction is provided with a first seating groove in which the first welding reinforcing protrusion is fitted.

5. The spindle motor of claim 2, wherein the welding reinforcing protrusion is a second welding reinforcing protrusion protruding from the sleeve in a direction toward the mounting part.

6. The spindle motor of claim 5, wherein the lowest portion of the mounting part in the axial direction is provided with a second seating groove in which the second welding reinforcing protrusion is fitted.

7. The spindle motor of claim 1, wherein the mounting part faces a housing of the hydrodynamic bearing assembly, the housing having a sleeve fitted therein.

8. The spindle motor of claim 7, wherein the welding reinforcing protrusion is a third welding reinforcing protrusion protruding from the mounting part in a direction toward the housing.

9. The spindle motor of claim 8, wherein the lowest portion of the housing in the axial direction is provided with a third seating groove in which the third welding reinforcing protrusion is fitted.

10. The spindle motor of claim 7, wherein the welding reinforcing protrusion is a fourth welding reinforcing protrusion protruding from the housing in a direction toward the mounting part.

11. The spindle motor of claim 10, wherein the lowest portion of the mounting part in the axial direction is provided with a fourth seating groove in which the fourth welding reinforcing protrusion is fitted.

12. The spindle motor of claim 1, wherein the lap welding is continuously provided along the portion in which the mounting part and the hydrodynamic bearing assembly face each other in a circumferential direction.

13. The spindle motor of claim 1, wherein the lap welding is provided as spot welding in which welding parts are spaced apart from each other by predetermined intervals along the portion in which the mounting part and the hydrodynamic bearing assembly face each other in a circumferential direction

14. The spindle motor of claim 1, wherein at least one portion in the portion in which the mounting part and the hydrodynamic bearing assembly face each other is provided by bonding coupling using an adhesive.

15. A spindle motor, comprising:
a base member including a mounting part; and
a hydrodynamic bearing assembly having a portion thereof fitted and fixed to the mounting part,
wherein a lowest portion in an axial direction in a portion in which the mounting part and the hydrodynamic bearing assembly face each other is provided with a welding reinforcing piece overlapping the mounting part and the hydrodynamic bearing assembly in the axial direction, and
the mounting part and the hydrodynamic bearing assembly are coupled to each other by lap welding in the axial direction through the welding reinforcing piece.

16. The spindle motor of claim 15, wherein the welding reinforcing piece is continuously provided along the portion in which the mounting part and the hydrodynamic bearing assembly face each other in a circumferential direction.

17. The spindle motor of claim 16, wherein the lap welding is continuously provided along the portion in which the mounting part and the hydrodynamic bearing assembly face each other in the circumferential direction.

18. The spindle motor of claim 16, wherein the lap welding is provided as spot welding in which welding parts are spaced apart from each other by predetermined intervals along the portion in which the mounting part and the hydrodynamic bearing assembly face each other in the circumferential direction.

19. The spindle motor of claim 15, wherein the welding reinforcing piece is provided such that welding parts thereof are spaced apart from each other by predetermined intervals along the portion in which the mounting part and the hydrodynamic bearing assembly face each other in a circumferential direction, and
the lap welding is provided as spot welding on a portion in which the welding reinforcing piece is disposed in the circumferential direction.

20. The spindle motor of claim 15, wherein at least one portion in the portion in which the mounting part and the hydrodynamic bearing assembly face each other is provided by bonding coupling using an adhesive.

21. The spindle motor of claim 15, wherein the mounting part faces a sleeve of the hydrodynamic bearing assembly.

22. The spindle motor of claim 15, wherein the mounting part faces a housing of the hydrodynamic bearing assembly, the housing having a sleeve fitted therein.

23. A hard disk drive, comprising:
the spindle motor of claim 1 having power applied thereto through a substrate to rotate a disk;
a magnetic head writing data to the disk and reading data from the disk; and
a head transfer unit transferring the magnetic head to a predetermined position above the disk.

24. A hard disk drive, comprising:
the spindle motor of claim 15 having power applied thereto through a substrate to rotate a disk;
a magnetic head writing data to the disk and reading data from the disk; and
a head transfer unit transferring the magnetic head to a predetermined position above the disk.
